(19) United States
(12) Patent Application Publication
(10) Pub. No.: US 2007/0004383 A1
(43) Pub. Date: Jan. 4, 2007

(54) Method and apparatus for providing a call reminder

(76) Inventor: Francis K. Agozo, Forest Park, IL (US)

Correspondence Address: MOTOROLA, INC., 1303 EAST ALGONQUIN ROAD, IL01/3RD, SCHAUMBURG, IL, 60196, US

(21) Appl. No.: 11/165,315

(22) Filed: Jun. 23, 2005

(51) Int. Cl. H04Q 7/38

(52) U.S. Cl. 455/414.1; 379/188

(57) ABSTRACT

In embodiments described herein, a reminder option is provided (310, 418, 606) for user input that subsequently reminds a user of a call event having a call identifier. In response to the user's selection of the reminder option, a reminder event associated with the call identifier is generated (314, 420, 608). According to various teachings, upon the reminder event being trigged (504), a plurality of reminder selections (510, 512, 514) is provided (510) for user input. A command (516, 522, 524, 526) is then executed based on a selected reminder selection from the plurality of reminder selections.

### TECHNICAL FIELD

This invention relates generally to methods for providing a call reminder.

### BACKGROUND

With the many advances in communications today, users are receiving more calls from various sources, such as interconnect calls, push-to-talk calls, cell phone calls, and instant messages. These numerous means of communications offer great flexibility in connecting people, but may be overwhelming at times for users. When the user is unable to immediately attend to a caller, the user can presently either respond with a quick message to call back the caller or simply ignore and/or end the call. In either case, there is often an intention to call back the caller at a later time. Users, however, often unintentionally forget their intention or commitment to return the call.

In fact, one of the indirect ways that users may be able to remember their commitment to return calls is by referring to the recent callers list. This, however, is not an acceptable solution, because not everyone on the recent callers list needs a returned call from the user. Worse still, users may simply forget to refer to their recent callers list promptly and thus experience the same problem of calls being returned late or never at all.

### BRIEF DESCRIPTION OF THE DRAWINGS

The above needs are at least partially met through provision of the reminder option described in the following detailed description, particularly when studied in conjunction with the drawings, wherein:

FIG. 1 comprises a wireless communications system suitable for various embodiments of the invention;

FIG. 2 comprises an overview of a mobile station according to various embodiments of the invention;

FIG. 3 comprises a flow chart diagram of a call option process triggered by a received call event according to one embodiment of the invention;

FIG. 4 comprises a flow chart diagram of a call option process triggered by a received access request of a recent caller list according to one embodiment of the invention;

FIG. 5 comprises a flow chart diagram of a reminder delivery process triggered by a reminder event according to one embodiment of the invention; and

FIG. 6 comprises a flow chart diagram of a termination process shown in FIGS. 3 and 5 according to one embodiment of the invention.

Skilled artisans will appreciate that elements in the figures are illustrated for simplicity and clarity and have not necessarily been drawn to scale. For example, the dimensions of some of the elements in the figures may be exaggerated relative to other elements to help improve understanding of various embodiments of the present invention. Also, common and well-understood elements that are useful or necessary in a commercially feasible embodiment are often not depicted in order to facilitate a less obstructed view of these various embodiments of the present invention.

### DETAILED DESCRIPTION

Generally speaking, pursuant to these various embodiments, a reminder option that subsequently reminds a user of a call event having a call identifier is provided for user input and a reminder event associated with the call identifier is generated responsive to the reminder option being selected by the user. According to one embodiment, the reminder event associated with the call identifier is saved, and/or alternatively, the reminder event is sent to a server. In an embodiment, the reminder option is provided to the user responsive to receiving the call event. According to another embodiment, after a recent caller list is provided for user selection, the reminder option is provided for user input responsive to the call event being selected from the recent caller list by the user. In one embodiment, the reminder option may also be provided to the user responsive to the call event being answered or terminated. According to one embodiment, providing the reminder option includes providing a plurality of call options for user input, which may include at least the reminder option, a respond option, and another user option. A call connection based on the call identifier is established responsive to the respond option being selected, and a user option is executed responsive to the other user option being selected.

According to various embodiments, a plurality of reminder selections for user input is provided responsive to a reminder event associated with a caller identifier being triggered. A command is then executed based on a selected reminder selection from the plurality of reminder selections. In one embodiment, the plurality of reminder selections includes a reminder selection that renews the reminder event associated with the call identifier when selected. The renewed reminder event associated with the call identifier is saved and/or sent to a server. According to an embodiment, the plurality of reminder selections includes a suspend reminder selection that suspends (e.g., removes locally and/or sends to the server) the reminder event when selected. The reminder selections also include a call selection according to one embodiment, wherein a call connection based on the call identifier is established responsive to the call selection being selected by the user.

According to various embodiments, an apparatus is also provided that includes a user interface, a reminder option circuit coupled to the user interface, and a reminder scheduler circuit coupled to the reminder option circuit. The reminder option circuit provides a reminder option for user input that subsequently reminds a user of a call event having a call identifier, and the reminder scheduler circuit generates a reminder event associated with the call identifier responsive to the reminder option being selected by the user. According to one embodiment, the reminder option circuit further provides a recent caller list having the call event for user selection. The reminder scheduler circuit also provides a plurality of reminder selections for user input responsive to the reminder event being triggered and executes a command based on a selected reminder selection from the plurality of reminder selections from the user.

Through these various teachings, a mechanism that introduces mobile station ergonomics and functionality changes has been presented that allows, among other things, users to mark a received call event with a call identifier for a call return. Specifically, users are provided with an option to convey their intent to return a call at a later time through the use of the reminder option. For example, users can now be provided this reminder option when an over-the-air call is received by the mobile station and/or when the recent caller lists are displayed. The reminder option is then associated to the call identifier for a subsequent call back reminder, which periodically alerts the users to remind them of their previously indicated intention to call someone back. Since this reminder option is generated based on a user request and/or input, multiple reminder selections are available to tailor the reminder option according to the needs of each user.

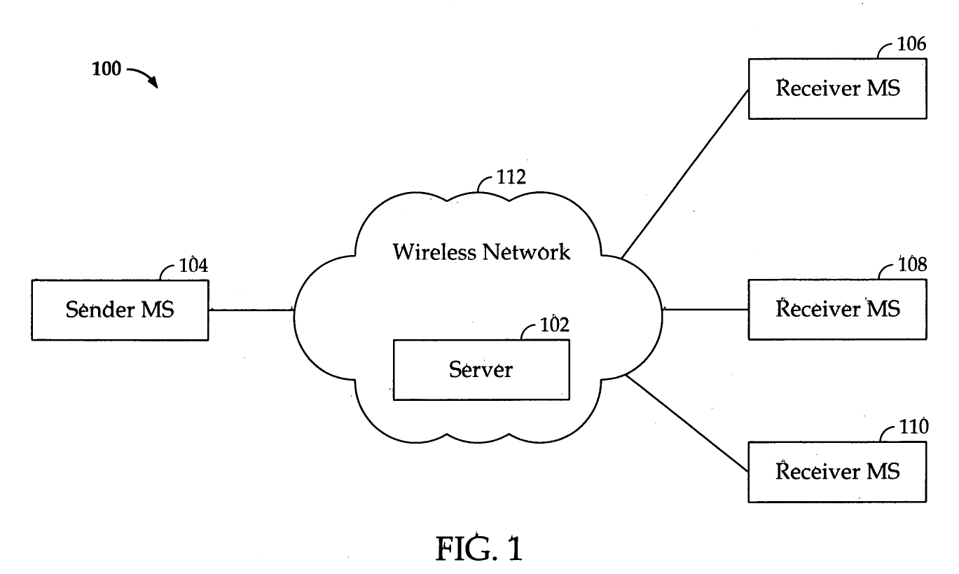

Referring now to the drawings, and in particular to FIG. 1, for purposes of providing an illustrative but non-exhaustive example to facilitate this description, a specific operational paradigm using a wireless communication system is shown and indicated generally at 100. Those skilled in the art, however, will recognize and appreciate that the specifics of this illustrative example are not specifics of the invention itself and that the teachings set forth herein are applicable in a variety of alternative settings. For example, since the teachings de scribed are not platform dependent, they can be applied to various systems, such as, but not limited to, Public Switched Telephone Networks (PSTNs), Code Division Multiple Access (CDMA) systems, Time Division Multiple Access (TDMA) systems, Universal Mobile Telecommunications Systems (UMTSs), Integrated Digital Enhanced Network (iDEN) systems, and General Packet Radio Service (GPRS) systems. In fact, any communication network that includes the feature of a call event is contemplated and is within the scope of the invention. Moreover, the call event as described includes any means of communication, including but not limited to interconnect calls, push-to-talk calls, cell phone calls, internet phone calls, and instant messages.

Referring now to the exemplary wireless communication system 100 shown in FIG. 1, a server 102 is included for exchanging communications between multiple sender mobile stations (“MSs”) (one shown) 104 and receiver MSs (three shown) 106, 108, 110 via a wireless network 112. For example, in one embodiment, when the sender MS 104 sends a call event to one receiver MS or multiple receiver MSs, the call event is generally sent to the server 102 for processing. The server 102, thus, includes any devices or components that Service the call event between the sender MS and the receivers MSs. For example, in the context of a cellular communication system, the server 102 would include the base stations, foreign agents, radio network controller, radio access network, Internet Protocol based servers, and so forth. As shown, numerous different implementations are possible through the various teachings provided, and other implementations using all or part of any component in the system, even if not specifically shown, are contemplated and thus are within the scope of the invention. Moreover, because current cell phones have many similar functions to that of computer devices, a mobile station will be herein used to refer to any device that can transmit data, which includes, but is not limited to, land-line telephones, cell phones, personal digital assistants, and/or computers.

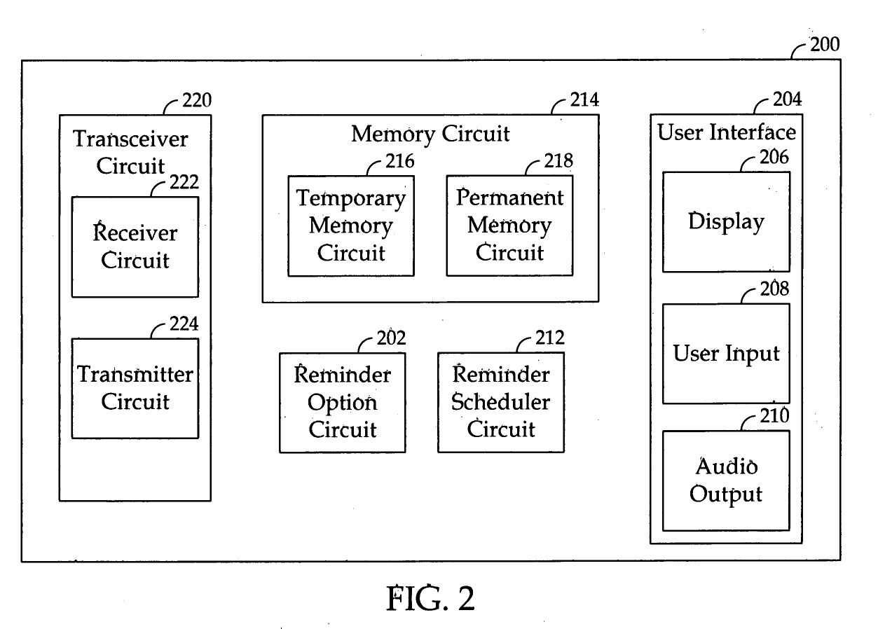

Referring to FIG. 2, a mobile station according to various embodiments of the invention is shown and indicated generally at 200. These various teachings contemplate either adapting the MSs 104, 106, 108, 110 and/or the server 102 to fully or partially implement the various embodiments described. As a result, the present transmitter circuit is given as one of many configurations and circuitry topologies available, and these various alternative embodiments, although not shown, are readily appreciated by one skilled in the art. Thus, they are within the scope of the various teachings described. The MS shown is a partial view of the circuit topology of a mobile device. As such, it should be understood that the various teachings may include other circuit components that are well known in the art that may not be shown. Moreover, “circuit” refers to one or more component devices such as, but not limited to, processors, memory devices, application specific integrated circuits (ASICs), and/or firmware, which are created to implement or adapted to implement (perhaps through the use of software) certain functionality, all within the scope of the various teachings described.

In this exemplary MS 200 shown, a reminder option circuit 202 is included for providing a reminder option for user input that subsequently reminds a user of a call event having a call identifier. Specifically, as is typically done at a MS, the reminder option is coupled to a user interface 204 that includes a display 206, which ultimately provides the reminder option. The user can then use a user input 208 of the user interface 204 to respond to the reminder option. An audio output 210 is also included as a part of the user interface 204 for audio communications for when the user wishes to accept the call event. The reminder option is also adapted to provide a recent caller list having multiple call events for user selection at the request of the user. Regardless of the trigger mechanism of the reminder option, if the user selects the reminder option, a reminder scheduler circuit 212, which is coupled to the reminder option circuit, is used to generate a reminder event associated with the call identifier from the call event.

According to various embodiments, the reminder option can either be saved locally on the mobile station and/or sent to the server. If the reminder option is saved and triggered internally at the mobile station, a memory circuit 214 having a temporary memory circuit 216 and a permanent memory circuit 218 is included for maintaining the reminder options along with their association with the call identifier. In one embodiment, when the reminder event is triggered, the reminder scheduler circuit 212 is further adapted to provide multiple reminder selections for user input. And in response to a selected reminder selection, a command based on the selected reminder selection is also executed by the reminder scheduler circuit. If, on the other hand, the reminder option is maintained and saved at the server, the reminder scheduler circuit 212 would then simply forward the reminder option to the server via a transceiver circuit 220. As is typically done in any MS, a receiver circuit 222 for receiving data and a transmitter circuit 224 for transmitting data are included in the transceiver circuit 220 to effectuate, among other things, this communications exchange between the server 102 and the MS 200.

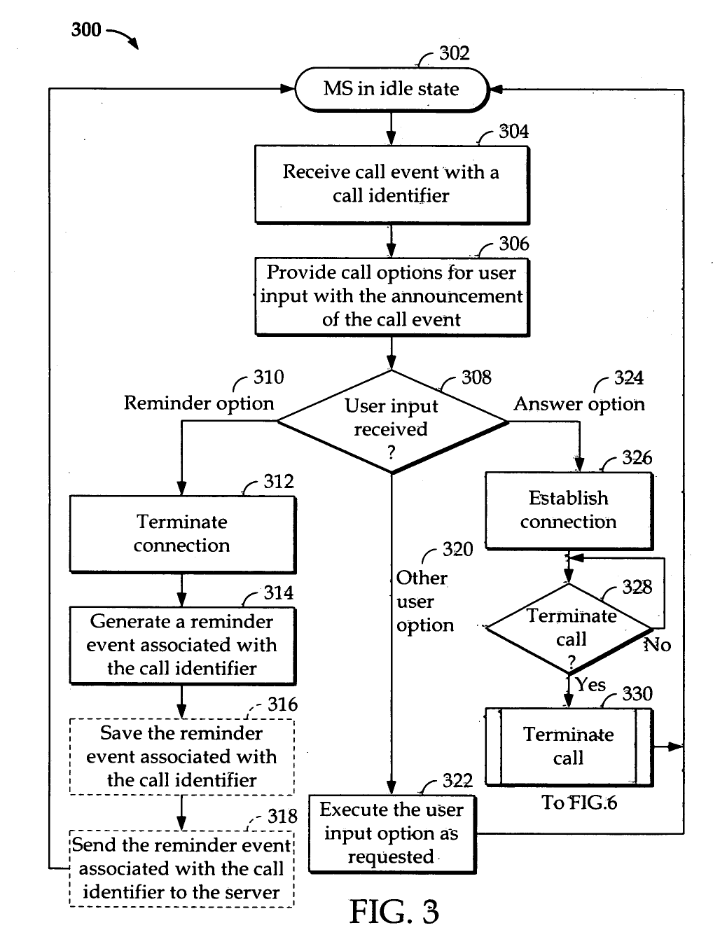

Turning now to FIG. 3, a flow diagram of a call option process triggered by a received call event is shown and indicated generally at 300. Although the process shown is preferably implemented at the mobile station 102, there may be other implementations of each of the processes shown that are better suited for the server in the communication system 100. These processes shown, thus, can be implemented fully or partially at any of the components within the system 100. Moreover, as one skilled in the art can readily appreciate, any of the processes shown can be altered in multiple ways to achieve the same functions and results of the various teachings described. As a result, these processes shown are one exemplary embodiment of multiple variation embodiments that may not be specifically shown. The processes shown are, thus, directed to the system 100, and each of them may be altered slightly to accommodate any of the components in the communications system. These other embodiments are within the scope of the various teachings described.

Turning to this particular call option process 300 shown, it starts 302 with the mobile station being in an idle state and shifting an active state upon receipt 304 of a call event having a call identifier. As is well known in the art, idle state typically refers to the MS either sitting idle from the usage standpoint and/or the MS being engaged in some other activity prior to the occurrence of some triggering events described according to various embodiments described. According to this embodiment shown, the user is provided 306 with call options, preferably along with the announcement of the call event according to one embodiment, responsive to the call event being received 304. The process 300 then determines 308 whether a user input has been received. Specifically, three user inputs are contemplated according to this embodiment shown. The user input may include a user selection of the reminder option 310. In this case, the connection that has been established by the incoming call event is terminated 312, followed by a reminder event associated with the call identifier of the call event being generated 314. This reminder event can be optionally saved 316 at the mobile station, specifically done with the embodiment where the mobile station internally maintains and triggers the reminder event. In the embodiment where the server externally maintains and triggers the reminder event, the reminder event is then accordingly sent 318 to the server. The process 300 then continues to loop back to the idle state 302.

Another call option includes a selection of other user option 320, which may include but is not limited to, for example, the user not responding after a predefined time, the user specifically selecting to ignore the call, the user placing a block on the call identifier of the call event, and/or like. Since numerous other user options are contemplated, the term “other user option” is used to capture the flexibility provided by these various embodiments, which provide multiple customizations of the call options available to the user. In short, the “other user option” includes any other call option selected by the user that is not the reminder option and/or the answer option. With the selection of this other user option, the selected user input option is accordingly executed 322 as requested. The process then loops back to the idle state 302 until a next call event is received.

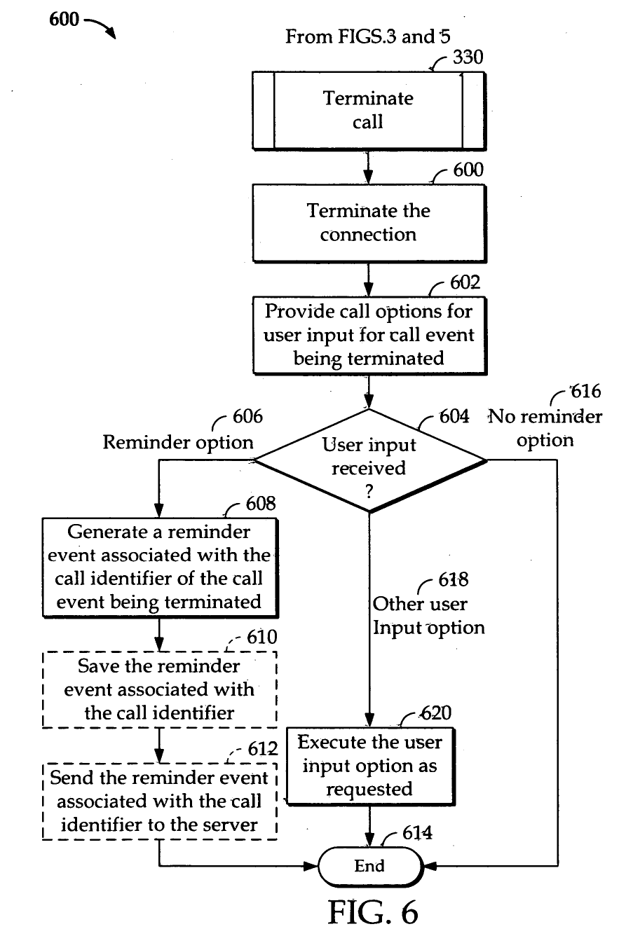

As a common user input, the user can select to answer the call event, which is referred to as an answer option 324. In this case, as typically done, the connection between the sender and receiver mobile stations is established 326 by the receiver user answering the call event. The process 300 keeps checking to determine 328 whether the call should be terminated either, for example, as a result of a disconnection and/or the users being finished with the call. If not, the process 300 continues to keep checking the status of the call until a termination is required. At this point, the call is accordingly terminated 330, which triggers a termination process shown in FIG. 6, and the process 300 continues to loops back to the idle state until a next call event is received.

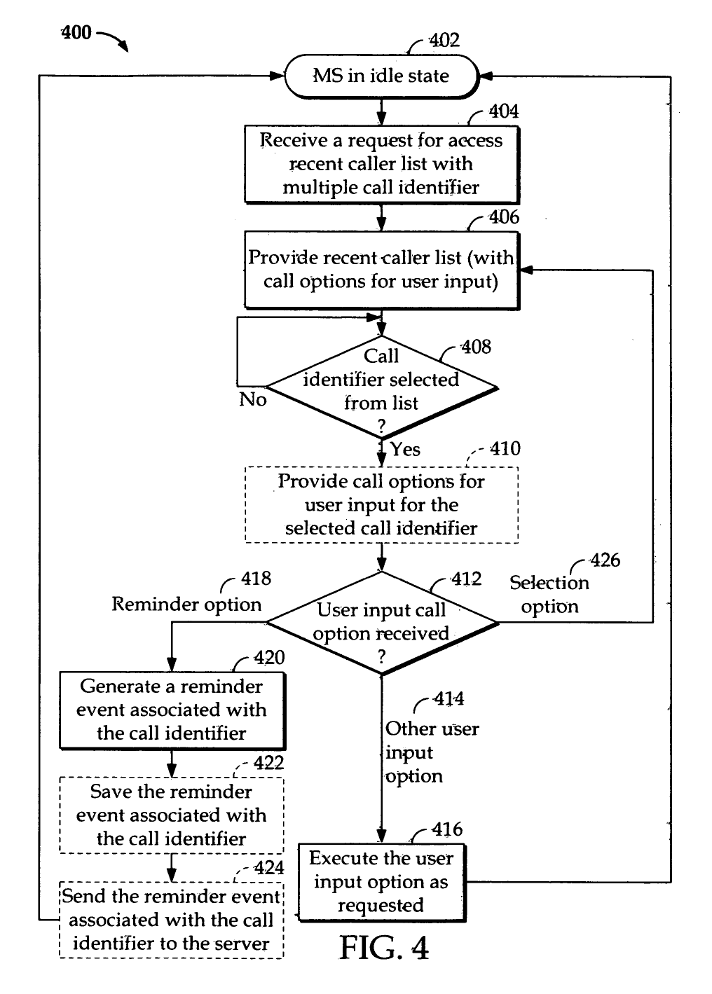

Turning now to FIG. 4, a flow chart diagram of a call option process triggered by a received access request of a recent caller list is shown and indicated generally at 400. In this process 400, it is similarly started 402 from the mobile station being in an idle state. Specifically, the process 400 is triggered from a request for access to a recent caller list with multiple call identifiers being received 402, which has been requested by the user. In response to such a request, the recent caller list is provided 406 to the user. According to one embodiment, the recent caller list is provided along with call options to the user. Once the recent caller list has been provided, the process waits for a user input by determining 408 whether a call identifier has been selected from the list by the user. In response to a call identifier being selected by the user, call options are optionally provided 410 for user input for the selected call identifier. This is shown as optional because multiple embodiments are contemplated. For example, the selected call identifier can be provided to the user without any options, but the user can push a function key on the mobile station that may trigger different call options. Another embodiment is to provide the selected call identifier along with specific call options. Either way, a user input call option is expected.

The process continues by checking whether such user input call option has been in fact received 412 from the user. Three call options are specifically shown, but numerous call options are captured by “other user input option” 414. If the other user input option is selected by the user, the user input option is executed 416 as requested. As before, if the reminder option 418 is selected, a reminder event associating the call identifier from the call event is generated 420. This reminder event is saved 422 on the mobile station and/or sent 424 to the server. In this embodiment, the call option can be a selection option 426 from the user as a request to go back to the recent caller list. If so, the process 400 accordingly loops back to provide 406 the recent caller list to the user.

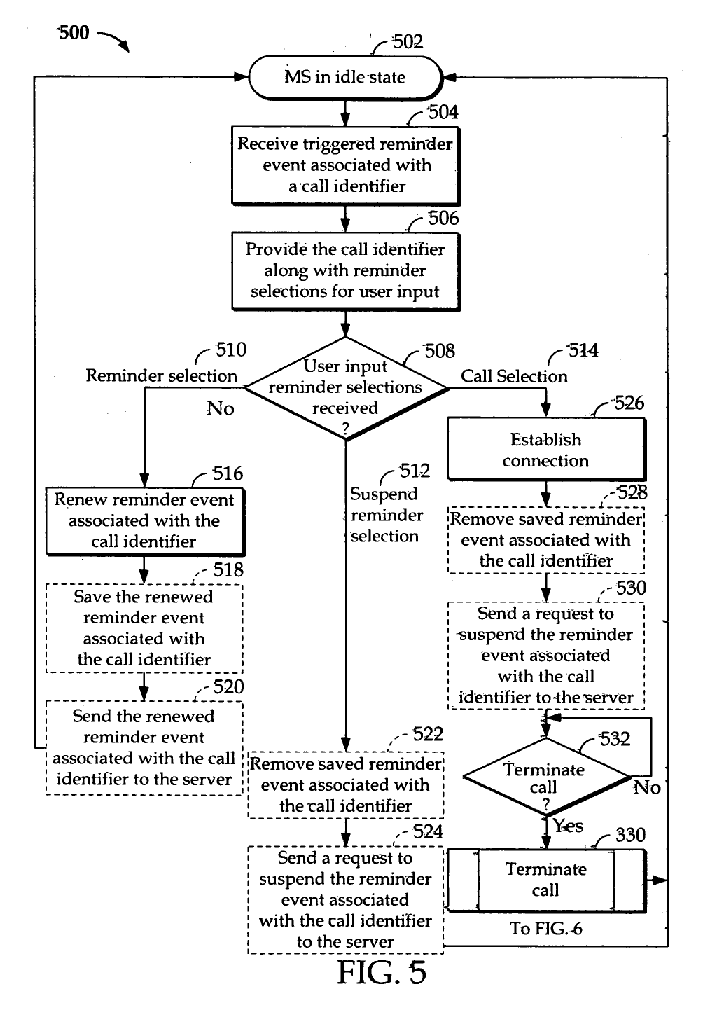

Turning now to FIG. 5, a flow chart diagram of a reminder delivery process triggered by a reminder event according to one embodiment of the invention is shown and indicated generally at 500. The reminder event, as is well know in the art, includes a scheduled trigger time duration. In other words, after a predefined time duration has passed, the reminder event is triggered, which starts 502 the process 500 from the idle state. This time duration for reminding the user can be predefined as a default value or specifically configured by the user. Responsive to receiving 504 this triggered reminder event, which is associated to a call identifier, the process 500 provides 506 the call identifier to the user. In particular, this call identifier is provided along with multiple reminder selections according to one embodiment.

It is then determined 508 whether such a reminder selection has been in fact received from the user. In this embodiment shown, there are three selections available: a reminder selection 510, a suspend reminder selection 512, and a call selection 514. When the reminder selection 510 is selected by the user, the reminder event associated with the call identifier is renewed 516. Depending upon the specific implementations, the renewed reminder event is either saved 518 locally and/or sent 520 to the server.

The user can also choose to suspend the reminder event, and in such a case, the suspend reminder selection 512 is selected. In response to this selection 512, the saved reminder event is removed 522 from the mobile station. In the case of the maintenance being handled by the server, a request is sent 524 to the server to suspend the reminder event.

The user, as another option, can select to call the call identifier, specifically referred to as the call selection 514. In this scenario, the connection between the user of the mobile station and the call identifier is established 526, in response to the call selection. Since the call selection is an indication that the user is returning the call, a reminder event is no longer necessary. Thus, to purge the records, the saved reminder event associated with the call identifier is removed 528. In the specific embodiment of the network implementation of the reminder events, a request to suspend the reminder event is sent 530 to the server. With an established connection, the process continuously checks to determine 532 whether the call should be terminated, and if so, it is accordingly terminated 330 by executing the termination process shown in FIG. 6.

Referring now to FIG. 6, a flow chart diagram of the termination process 330 of FIGS. 3 and 5 is shown. According to various embodiments, the termination process 316 provides a way for the user to again select a reminder option for the call being terminated. The termination process 316 first terminates 600 the previously established connection of the call, but instead of ending the process, call options for the call event being terminated are provided 602 for user input. The process 316 keeps checking to determine 604 whether a user input has been received. In this embodiment shown, three call options are contemplated. The first one is the reminder option 606. The user can again assign a new reminder to the terminated call event even though a call has been previously established. In response to the reminder option 606, a reminder event associating the call identifier of the terminated call event is generated 608. With the various embodiments as discussed before, the reminder event is either saved 610 locally and/or sent 612 to the server, which ends 614 the termination process 330 to be returned to the previous FIGS. 3 and 5. Conversely, the user can indicate that no reminder option 616 is needed. In this case, the process 330 simply ends 614 at this point. The user can select an option that does not relate to the reminder option, which is referred to as “other user input option” 618 for generality. In response to a user input option from the user, the termination process 330 accordingly executes 620 the user input option as requested, and the process is brought 614 to an end at this point.

With these various teachings, embodiments have been presented that introduce mobile station ergonomics and functionality changes that allow, among other things, users to select a reminder option for call back of a received call event linked to a call identifier. Specifically, the users are provided with a reminder option as a way for users to convey their intent to return a call at a later time. For example, users may be provided with this reminder option when an over-the-air call is received by the mobile station and/or when the recent caller lists are displayed. The reminder option is then associated with the call identifier for a subsequent call back reminder, which periodically alerts the users to remind them of their previously indicated intention to call someone back. Since this reminder option is generated based upon user requests and/or inputs, multiple reminder selections can be configured to tailor the reminder option according to the needs of each user.

Those skilled in the art will recognize that a wide variety of modifications, alterations, and combinations can be made with respect to the above described embodiments without departing from the spirit and scope of the invention, and that such modifications, alterations, and combinations are to be viewed as being within the ambit of the inventive concept.

We claim:

1. A method comprising:
providing a reminder option for user input that subsequently reminds a user of a call event having a call identifier;
generating a reminder event associated with the call identifier responsive to the reminder option being selected by the user.

2. The method according to claim 1 further comprising:
saving the reminder event associated with the call identifier.

3. The method according to claim 1 further comprising:
sending the reminder event associated with the call identifier to a server.

4. The method according to claim 1 further comprising, prior to providing the reminder option for user input:
receiving the call event having the call identifier, wherein the reminder option is provided to the user responsive to receiving the call event.

5. The method according to claim 1 further comprising, prior to providing the reminder option for user input:
providing a recent caller list for user selection, wherein the reminder option is provided to the user responsive to the call event being selected from the recent caller list.

6. The method according to claim 1 further comprising, prior to providing the reminder option for user input:
answering the call event, wherein the reminder option is provided to the user responsive to answering the call event.

7. The method according to claim 1 further comprising, prior to providing the reminder option for user input:
terminating an established connection triggered by the call event, wherein the reminder option is provided to the user responsive to terminating the established connection.

8. The method according to claim 1, wherein providing the reminder option further comprises:
providing a plurality of call options for user input comprising at least the reminder option and a respond option;
establishing a call connection based on the call identifier responsive to the respond option being selected.

9. The method according to claim 8, wherein the plurality of call options comprises other user option, and wherein the method further comprises:
executing a user option responsive to the other user option being selected.

10. A method comprising:
providing a plurality of reminder selections for user input responsive to a reminder event associated with a call identifier being triggered;
executing a command based on a selected reminder selection from the plurality of reminder selections.

11. The method according to claim 10, wherein the plurality of reminder selections comprises a reminder selection, and the method further comprises:
renewing the reminder event associated with the call identifier to provide a renewed reminder event responsive to the reminder option being selected by a user.

12. The method according to claim 11 further comprising:
saving the renewed reminder event associated with the call identifier.

13. The method according to claim 11 further comprising:
sending the renewed reminder event associated with the call identifier to a server.

14. The method according to claim 10, wherein the plurality of reminder selections comprises a suspend reminder selection, and the method further comprises:
suspending the reminder event associated with the call identifier responsive to the suspend reminder selection being selected by a user.

15. The method according to claim 14 further comprising:
removing the reminder event associated with the call identifier responsive to the suspend reminder selection being selected by a user.

16. The method according to claim 14 further comprising:
sending a request to suspend the reminder event associated with the call identifier to a server responsive to the suspend reminder selection being selected by a user.

17. The method according to claim 10, wherein the plurality of reminder selections comprises a call selection, and the method further comprises:
establishing a call connection based on the call identifier responsive to the call selection being selected by a user.

18. An apparatus comprising:
a user interface;
a reminder option circuit coupled to the user interface that provides a reminder option for user input that subsequently reminds a user of a call event having a caller identifier;
a reminder scheduler circuit coupled to the reminder option circuit that generates a reminder event associated with the call identifier responsive to the reminder option being selected by the user.

19. The apparatus as defined in claim 18, wherein the reminder option circuit provides a recent caller list having the call event for user selection.

20. The apparatus as defined in claim 18, wherein the reminder scheduler circuit provides a plurality of reminder selections for user input responsive to the reminder event associated with the call identifier being triggered and executes a command based on a selected reminder selection from the plurality of reminder selections from the user.
